(19) United States
(12) Patent Application Publication
(10) Pub. No.: US 2020/0057524 A1
(43) Pub. Date: Feb. 20, 2020

(54) TOUCH SENSING DEVICE AND TOUCH SENSING METHOD

(71) Applicant: Raydium Semiconductor Corporation, Hsinchu (TW)

(72) Inventors: Chun-Wei YANG, Hsinchu (TW); Chih-Hsiung CHEN, Zhubei City, Hsinchu County (TW); Yu-Chin HSU, Hsinchu City (TW); Chih YUAN, New Taipei City (TW)

(21) Appl. No.: 16/505,989

(22) Filed: Jul. 9, 2019

(30) Foreign Application Priority Data
Aug. 14, 2018 (TW) 107128359

(51) Int. Cl. G06F 3/041; G06F 3/044

(52) U.S. Cl. CPC G06F 3/0416; G06F 3/044

(57) ABSTRACT

A touch sensing device includes an amplifier, a charge measurer, and a comparator. The amplifier has an input terminal and an output terminal. The charge measurer is electrically connected to the input terminal of the amplifier, configured to measure a volume of charges on the input terminal of the amplifier with different measuring basis. The comparator is configured to compare an output voltage on the output terminal of the amplifier with a reference voltage.

### BACKGROUND OF THE INVENTION

### 1. Field of the Invention

The invention relates to an electronic device and method; in particular, to a touch sensing device and a touch sensing method.

### 2. Description of the Prior Art

With the development of technology, touch sensing devices have been widely used in people's lives.

In general, the touch sensing device can be applied to a display panel and can determine the position of the finger by sensing an electrical change on the display panel. However, as the resolution of the display panel increases, the processing time of the touch sensing device becomes shorter. Therefore, how to make the touch sensing device shorten the processing time while maintaining the accuracy is an important issue in the field.

### SUMMARY OF THE INVENTION

Therefore, the invention provides a touch sensing device and a touch sensing method to solve the above-mentioned problems of the prior arts.

A preferred embodiment of the invention is a touch sensing device. In this embodiment, the touch sensing device includes an amplifier, a charge measurer and a comparator. The amplifier has an input terminal and an output terminal. The charge measurer is electrically connected to the input terminal of the amplifier and configured to measure a volume of charges on the input terminal of the amplifier with different charge measuring basis. The comparator is configured to compare an output voltage on the output terminal of the amplifier with a reference voltage.

In an embodiment, the charge measurer includes a first capacitor and a second capacitor. The charge measurer uses the first capacitor and the second capacitor to measure an original sensed charge on the input terminal of the amplifier with different charge measuring basis.

In an embodiment, the charge measurer further includes a first switch, a second switch and a third switch. The first switch is electrically connected between the first capacitor and the input terminal of the amplifier. The second switch is electrically connected between the second capacitor and the input terminal of the amplifier. The third switch is electrically connected between the first capacitor and a charge releasing terminal.

In an embodiment, conduction periods of the first switch and the third switch are different.

In an embodiment, the charge measurer further includes a fourth switch electrically connected between the first capacitor and a power supply terminal.

In an embodiment, conduction periods of the first switch and the fourth switch are different.

In an embodiment, the charge measurer includes a variable capacitor and a variable capacitor switch. The variable capacitor switch is electrically connected between the variable capacitor and the input terminal of the amplifier.

In an embodiment, the comparator is also configured to provide a disable signal to stop the operation of the charge measurer according to a comparing result of the output voltage and the reference voltage.

Another preferred embodiment of the invention is a touch sensing method. In this embodiment, the touch sensing method includes: (a) releasing charges on an input terminal of an amplifier with a first volume of charges; (b) releasing the charges on the input terminal of the amplifier with a second volume of charges, wherein the first volume of charges and the second volume of charges are different; and (c) estimating an original sensed charge on the input terminal of the amplifier according to a number of times releasing the charges on the input terminal of the amplifier with the first volume of charges and a number of times releasing the charges on the input terminal of the amplifier with the second volume of charges.

Another preferred embodiment of the invention is a touch sensing device. In this embodiment, the touch sensing device includes an amplifier, a first switch, a first capacitor, a second switch, a second capacitor, a third switch and a comparator. The amplifier has an input terminal and an output terminal. A first terminal of the first switch is electrically connected to the input terminal of the amplifier. A first terminal of the first capacitor is electrically connected to a second terminal of the first switch. A first terminal of the second switch is electrically connected to the input terminal of the amplifier. A first terminal of the second capacitor is electrically connected to a second terminal of the second switch. A first terminal of the third switch is electrically connected to a charge releasing terminal. A first input terminal of the comparator is electrically connected to the output terminal of the amplifier, and a second input terminal of the comparator is configured to receive a reference voltage.

Compared to the prior art, the touch sensing device and the touch sensing method of the invention can reduce charge measurement time under the condition of maintaining touch sensing accuracy.

The advantage and spirit of the invention may be understood by the following detailed descriptions together with the appended drawings.

### BRIEF DESCRIPTION OF THE APPENDED DRAWINGS

FIG. 1 illustrates a schematic diagram of the display device in an embodiment of the invention.

FIG. 2 illustrates a schematic diagram of the touch sensing device in an embodiment of the invention.

FIG. 3 illustrates a schematic diagram of the charge measuring operation in another embodiment of the invention.

FIG. 4 illustrates a schematic diagram of the touch sensing device in another embodiment of the invention.

FIG. 5 illustrates a schematic diagram of the touch sensing device in another embodiment of the invention.

FIG. 6 illustrates a flowchart of the touch sensing method in another embodiment of the invention.

### DETAILED DESCRIPTION OF THE INVENTION

The spirit of the present disclosure will be apparent from the following description of the embodiments of the present disclosure, which can be modified by the teachings of the present disclosure. And, modifications that do not depart from the spirit and scope of the disclosure.

As used herein, “first”, “second”, . . . , etc. are not specifically intended to refer to the order or order, nor are they intended to limit the invention, only to distinguish between elements described in the same technical terms or operation.

As used herein, “electrically coupled” may mean that two or more elements are in direct physical or electrical contact with each other, or indirectly in physical or electrical contact with each other, and “electrically coupled”. It can also mean that two or more elements operate or act on each other.

The terms “including”, “including”, “having”, “including”, and the like, as used herein, are meant to be open-ended, meaning to include but not limited to.

As used herein, “and/or” includes any or all combinations of the recited.

With regard to the directional terms used herein, such as: up, down, left, right, front or back, etc., only the direction of the additional drawing is referred to. Therefore, the directional terminology used is used to illustrate that it is not intended to limit the case.

Terms used herein have the usual meaning of each term used in the art, in the context of the disclosure, and in the particular content, unless otherwise specified. Certain terms used to describe the disclosure are discussed below or elsewhere in this specification to provide additional guidance to those skilled in the art in the description of the disclosure.

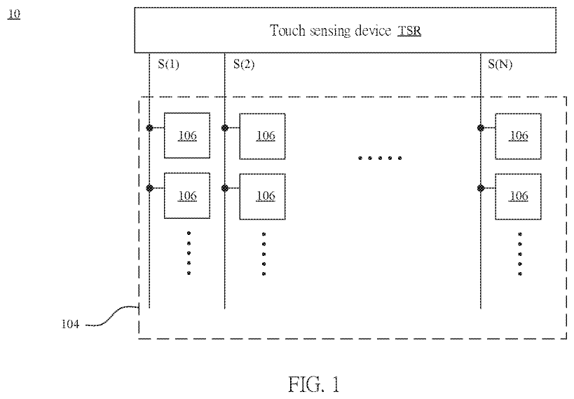

FIG. 1 illustrates a schematic diagram of the display device 10 according to an embodiment of the invention. In this embodiment, the display device 10 includes a sensing circuit 106 and a touch sensing device TSR. In an embodiment, the sensing circuit 106 is arranged in a matrix form and disposed in an active area 104. In an embodiment, the sensing circuit 106 includes a touch sensing electrode (not shown). In an embodiment, the sensing circuit 106 is electrically connected to the touch sensing device TSR through the sensing line to provide the touch sensing signals S(1), S(2), . . . , S(N) to the touch sensing device TSR, wherein N is a natural number. In an embodiment, the touch sensing device TSR can receive the touch sensing signals S(1), S(2), . . . . , S(N) and measure sensed charges corresponding to the touch sensing signal S(1), S(2), . . . , S(N) accordingly to determine the touch coordinates.

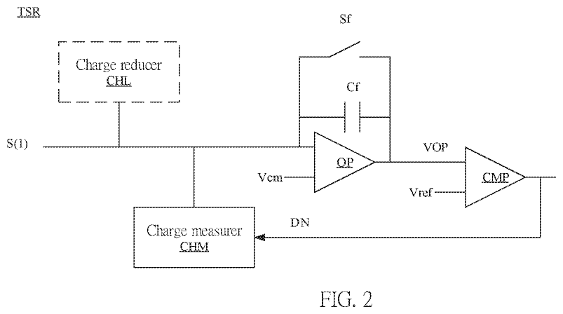

Please refer to FIG. 2. FIG. 2 illustrates a schematic diagram of the touch sensing device TSR according to an embodiment of the invention. It should be noted that although the circuit for measuring the sensed charges corresponding to the touch sensing signal S(1) in the touch sensing device TSR is taken as an example, the touch sensing device TSR can also include circuits for measuring the sensing signals S(2)-S(N), so the invention is not limited to the circuit shown in FIG. 2.

In an embodiment, the touch sensing device TSR includes an amplifier OP, a charge measurer CHM, a storage capacitor Cf, a switch Sf and a comparator CMP.

In an embodiment, a first input terminal of the amplifier OP is electrically connected to the charge measurer CHM, a second input terminal of the amplifier OP is used to receive the reference voltage Vcm, and an output terminal of the amplifier OP is electrically connected to the first input terminal of the comparator CMP. In an embodiment, the storage capacitor Cf is electrically connected between the first input terminal and the output terminal of the amplifier OP, and the switch Sf is electrically connected between the first input terminal and the output terminal of the amplifier OP and coupled in parallel to the storage capacitor Cf.

In an embodiment, the storage capacitor Cf is used to store the sensed charges corresponding to the touch sensing signal S(1). In an embodiment, the switch Sf is used to reset the storage capacitor Cf. In an embodiment, the amplifier OP is configured to generate and output an output voltage VOP to the first input terminal of the comparator CMP according to the input voltage on the first input terminal of the amplifier OP and the reference voltage Vcm.

In an embodiment, the second input terminal of the comparator CMP is configured to receive the reference voltage Vref, and the output terminal of the comparator CMP is used to output a disable signal DN. In an embodiment, the comparator CMP is configured to output a voltage VOP and a reference voltage Vref, and generate the disable signal DN according to the comparison result. In an embodiment, the charge measurer CHM stops its operation according to the disable signal DN.

In an embodiment, the charge measurer CHM is used to measure the volume of charges on the first input terminal of the amplifier OP (e.g., the amount of charges stored in the storage capacitor Cf) with different charge measuring basis.

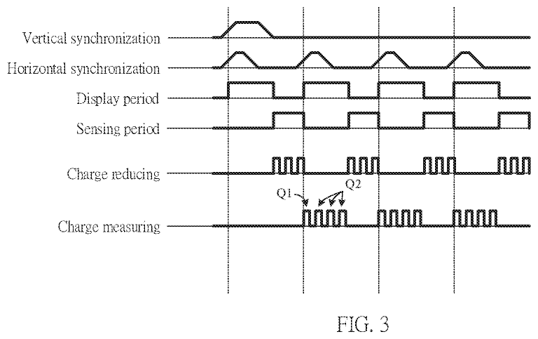

Please refer to FIG. 3. In an embodiment, the charge measurer CHM can perform a charge measurement operation during the display period. In an embodiment, in the first charge measurement operation, the charge measurer CHM can release the charges on the first input terminal of the amplifier OP with a first charge measuring basis Q1. Then, in the second, third and fourth charge measurement operations, the charge measurer CHM can release the charges on the first input terminal of the amplifier OP with a second charge measuring basis Q2 respectively. Then, if the comparator CMP generates the disable signal DN according to the comparison result between the output voltage VOP and the reference voltage Vref (it can be judged that the charges on the first input terminal of the amplifier OP has been substantially released), the charge measurer CHM can stop releasing the charges on the first input terminal of the amplifier OP based on the disable signal DN. And, after the disable signal DN is generated, the touch sensing device TSR estimates an original sensed charge on the first input terminal of the amplifier OP according to a number of times releasing the charges with the first charge measuring basis Q1 and a number of times releasing the charges with the second charge measuring basis Q2.

In an embodiment, the second charge measuring basis Q2 is different from the first charge measuring basis Q1. In an embodiment, the second charge measuring basis Q2 is smaller than the first charge measuring basis Q1.

By measuring the amount of charges on the first input terminal of the amplifier OP by using different charge measuring basis as described above, the measurement time of the charge measurer CHM can be reduced while maintaining accuracy.

It should be noted that, in the above embodiment, four charge measurement operations are performed with two charge measuring basis Q1 and Q2 during each horizontal synchronization period, but in different embodiments, the charge measurer CHM can measure the amount of charges with different number of charge measuring basis (e.g., three charge measuring basis or more) according to practical requirements, and the horizontal synchronization period can be performed other times (e.g., 2 times, 3 times or more than 5 times) according to practical requirements. Therefore, the invention is not limited to the above embodiments.

In an embodiment, the charge measurer CHM repeatedly releases the charges on the first input terminal of the amplifier OP with a varying amount of charges until the output voltage VOP is greater than, equal to or less than the reference voltage Vref. At this time, the comparator CMP provides the disable signal DN to the charge measurer CHM to stop the operation of the charge measurer CHM. In an embodiment, the levels of the reference voltage Vref and the reference voltage Vcm are substantially the same, but not limited to this.

Furthermore, the touch sensing device TSR records the number of times that the charge measurer CHM releases the charges on the first input terminal of the amplifier OP and the amount of charges released each time, and accordingly calculates the original sensed charges on the first input terminal of the amplifier OP.

For example, after the charge detector CHM releases the charges on the first input terminal of the amplifier OP once with 5 microcoulombs and releases the charges on the first input terminal of the amplifier OP 3 times with 1 microcoulomb, the comparator CMP outputs the disable signal DN to the charge measurer CHM, it can be estimated that the original sensed charges on the first input terminal of the amplifier OP is 8 microcoulombs.

In an embodiment, the touch sensing device TSR can further include a charge reducer CHL. The charge reducer CHL can be used to reduce the amount of charges corresponding to the sensing signal S(1) during the sensing period (please refer to FIG. 3) to reduce the capacity of the storage capacitor Cf. In some embodiments, the charge reducer CHL can be adaptively omitted.

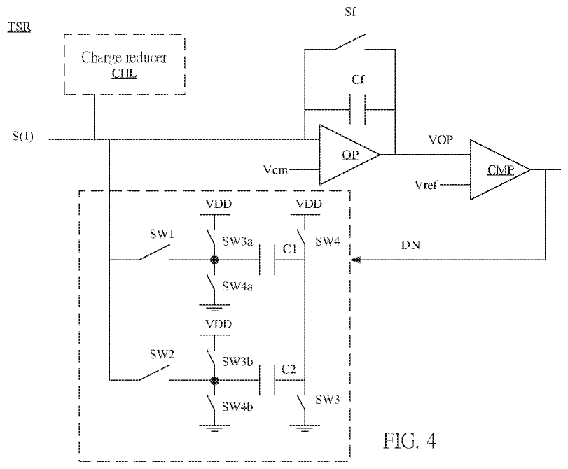

Please refer to FIG. 4. In an embodiment, the charge measurer CHM includes switches SW1˜SW4, SW3a˜SW3b, SW4a˜SW4b and capacitors C1˜C2. In an embodiment, the capacitances of the capacitors C1˜C2 are different. In another embodiment, the capacitances of the capacitors C1˜C2 can be the same.

In this embodiment, the switch SW1 is electrically connected between the first terminal of the capacitor C1 and the first input terminal of the amplifier OP. In an embodiment, the switch SW1 is conducted to transfer the charges on the first input terminal of the amplifier OP into the capacitor C1.

In this embodiment, the switch SW2 is electrically connected between the first terminal of the capacitor C2 and the first input terminal of the amplifier OP. In an embodiment, the switch SW2 is conducted to transfer the charges on the first input terminal of the amplifier OP into the capacitor C2.

In this embodiment, the switch SW3 is electrically connected between the second terminals of the capacitors C1˜C2 and the charge releasing terminal. In an embodiment, when the switch SW3 is conducted, the charges stored in the capacitors C1˜C2 will be released to the charge releasing terminal. In an embodiment, the charge releasing terminal can be ground.

In this embodiment, the switch SW4 is electrically connected between the second terminals of the capacitors C1˜C2 and the power supply terminal of the voltage VCC. In an embodiment, when the switch SW4 is conducted, the voltage VCC is provided to the second terminal of the capacitors C1˜C2. In some embodiments, the power supply terminal of the voltage VCC and the switch SW4 can be adaptively omitted.

In an embodiment, the on-times of the switches SW1˜SW4 are different. In an embodiment, the on-times of the switches SW1˜SW2 can be partially the same.

In an embodiment, the switches SW4a˜SW4b are electrically connected between the first terminals of the capacitors C1˜C2 and the ground respectively.

In an embodiment, the switches SW3a˜SW3b are electrically connected between the first terminals of the capacitors C1˜C2 and the power supply terminal of the voltage VCC respectively. In an embodiment, when the switches SW3a˜SW3b are conducted respectively, the voltage VCC is provided to the first terminals of the capacitors C1˜C2. In some embodiments, the switches SW3a˜SW3b can be adaptively omitted.

In an embodiment, the on-times of the switches SW4a˜SW4b are the same as the on-time of the switch SW4. In an embodiment, the on-times of the switches SW3a˜SW3b are the same as the on-time of the switch SW3.

The following paragraphs will explain the details of the charge measurer CHM by some embodiments, but the invention is not limited thereto.

In the first operation state, the switches SW1, SW2, SW3, SW3a and SW3b are not conducted, and the switches SW4, SW4a and SW4b are conducted. At this time, the switch SW4 provides the voltage VCC to the second terminals of the capacitors C1˜C2, and the first terminals of the capacitors C1˜C2 are grounded through the switches SW4a˜SW4b respectively.

In the second operation state after the first operation state, the switch SW1 is conducted, and the switches SW2, SW3, SW3a, SW3b, SW4, SW4a and SW4b are not conducted. At this time, the charge on the first input terminal of the amplifier OP can be transferred to the capacitor C1 through the conducted switch SW1.

In the third operation state after the second operation state, the switches SW3, SW3a and SW3b are conducted, and the switches SW1, SW2, SW4, SW4a and SW4b are not conducted. At this time, the charges stored in the capacitor C1 can be released to the charge releasing terminal through the switch SW3.

It should be noted that in various embodiments, the charge measurer CHM can perform the second operational state and the third operational state sequentially, simultaneously or partially simultaneously. That is, the switch group including the switches SW3, SW3a and SW3b and the switch SW1 can be sequentially conducted, simultaneously conducted or the on-times of them are partially overlapped.

Thereby, the charges on the first input terminal of the amplifier OP can be released by the capacitor C1.

Similarly, in the second operation state, the switch SW2 is conducted, and the switches SW1, SW3, SW3a, SW3b, SW4, SW4a and SW4b are not conducted. At this time, the charges on the first input terminal of the amplifier OP is transferred to the capacitor C2 through the conducted switch SW2. Thereby, the charges on the first input terminal of the amplifier OP can be released by the capacitor C2.

Similarly, in the second operation state, the switches SW1˜SW2 are conducted, and the switches SW3, SW3a, SW3b, SW4, SW4a and SW4b are not conducted. At this time, the charges on the first input terminal of the amplifier OP are respectively transferred to the capacitors C1˜C2 through the switches SW1˜SW2. Thereby, the charges on the first input terminal of the amplifier OP can be released by the capacitors C1˜C2.

With this arrangement, the charge measurer CHM can select different charge amounts to release the charges on the first input terminal of the amplifier OP as needed until the comparator CMP provides the disable signal DN to the charge measurer CHM.

For example, the charge measurer CHM can release 7 microcoulombs of charge once with the capacitor C1 and release 3 microcoulombs of charge 2 times with the capacitor C2 in the same charge measurement period (e.g., the same horizontal synchronization period) and then receive the disable signal DN. In this case, the capacitances of the capacitor C1 and the capacitor C2 are different. In this way, it can be estimated that the original sensed charges on the first input terminal of the amplifier OP is 7+2*3=13 microcoulombs in this charge measurement period.

For example, the charge measurer CHM can release 6 microcoulombs of charge once with the capacitors C1 and C2 in order in the same charge measurement period, and release 3 microcoulombs of charge 2 times with the capacitor C2 and then receive the disable signal DN. In this case, the capacitances of the capacitor C1 and the capacitor C2 are the same. In this way, it can be estimated that the original sensed charge on the first input terminal of the amplifier OP is 6+2*3=12 microcoulombs in this charge measurement period.

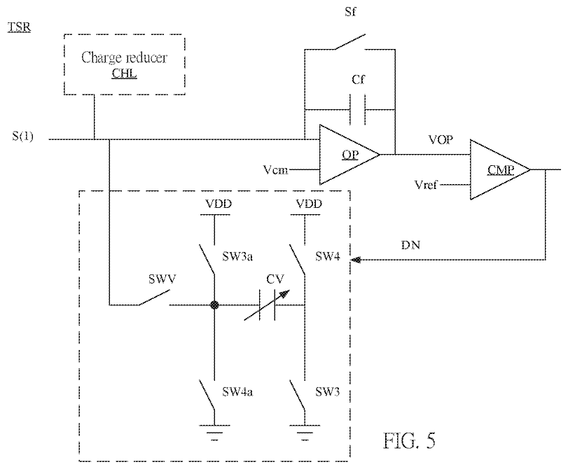

Please refer to FIG. 5. In another embodiment, the charge measurer CHM can include switches SWV, SW3, SW3a, SW4, SW4a and a variable capacitor CV.

In this embodiment, the switch SWV is electrically connected between the first terminal of the capacitor CV and the first input terminal of the amplifier OP. In an embodiment, when the switch SWV is conducted, the charges on the first input terminal of the amplifier OP can be transferred into the capacitor CV.

In this embodiment, the switch SW3 is electrically connected between the second terminal of the capacitor CV and the charge releasing terminal. In an embodiment, when the switch SW3 is conducted, the charges stored in the capacitor CV can be released to the charge releasing terminal. In an embodiment, the charge releasing terminal can be ground.

In this embodiment, the switch SW4 is electrically connected between the second terminal of the capacitor CV and the power supply terminal of the voltage VCC. In an embodiment, when the switch SW4 is conducted, the voltage VCC can be provided to the second terminal of the capacitor CV. It should be noted that in some embodiments, the power supply terminal of the voltage VCC and the switch SW4 can be adaptively omitted.

In an embodiment, the on-times of the switches SWV, SW2, SW3 and SW4 are different.

In an embodiment, the switch SW4a is electrically connected between the first terminal of the capacitor CV and the ground.

In an embodiment, the switch SW3a is electrically connected between the first terminal of the capacitor CV and the power supply terminal of the voltage VCC. In one embodiment, when the switch SW3a is conducted, the voltage VCC can be provided to the first terminal of the capacitor CV. In some embodiments, the switch SW3a can be adaptively omitted.

In an embodiment, the on-time of the switch SW4a is the same as the on-time of the switch SW4. In an embodiment, the on time of the switch SW3a is the same as the on-time of the switch SW3.

In the first operation state, the switch SWV, SW3 and SW3a are not conducted, and the switch SW4 and SW4a are conducted. At this time, the switch SW4 provides the voltage VCC to the second terminal of the variable capacitor CV, and the first terminal of the capacitor CV is grounded through the switch SW4a.

In the second operational state after the first operational state, the switch SWV is conducted, and the switch SW3, SW3a, SW4 and SW4a are not conducted. At this time, the charges on the first input terminal of the amplifier OP can be transferred to the variable capacitor CV through the switch SWV.

In the third operation state after the second operation state, the switches SW3 and SW3a are conducted, and the switches SWV, SW4 and SW4a are not conducted. At this time, the charges stored in the variable capacitor CV is released to the charge releasing terminal through the conducted switch SW3.

It should be noted that in various embodiments, the charge measurer CHM can perform the second operational state and the third operational state sequentially, simultaneously or partially simultaneously. That is, the switch group including the switches SW3 and SW3a and the switch SW1 can be sequentially conducted, simultaneously conducted or partially simultaneously conducted.

Thereby, the charges on the first input terminal of the amplifier OP can be released by the capacitor CV. And, by setting in this way, the charge measurer CHM can use different charge amounts to release the charges on the first input terminal of the amplifier OP as needed until the comparator CMP provides the disable signal DN to the charge measurer CHM.

For example, the charge measurer CHM can sequentially release 7 microcoulombs of charges once with the variable capacitance CV having the first capacitance and release 3 microcoulombs of charges twice with the variable capacitance CV having the second capacitance during the same charge measurement period (e.g., the same horizontal synchronization period), and then receive the disable signal DN. In this way, it can be estimated that the original sensed charges on the first input terminal of the amplifier OP is 7+2*3=13 microcoulombs in this charge measurement period.

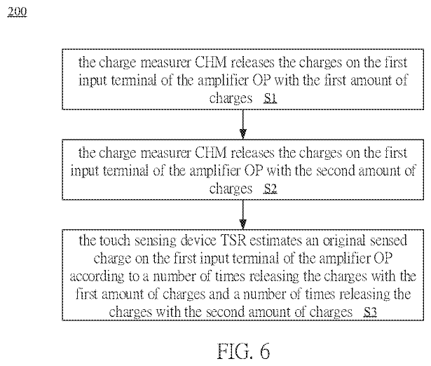

FIG. 6 is a flowchart of the touch sensing method 200 according to another embodiment of the invention.

The touch sensing method 200 can be applied to the touch sensing device TSR the same or similar to the structure shown in FIG. 2. In order to simplify the description, the following describes the touch sensing method 200 by taking the touch sensing device TSR in FIG. 2 as an example, but the invention is not limited to this case.

In addition, it should be understood that except where the order is specifically stated, the operation of the touch sensing method 200 mentioned in the embodiment can be adjusted according to actual needs, even all steps or a part of steps can be performed simultaneously.

Furthermore, such operations can be adaptively added, replaced and/or omitted in various embodiments.

In this embodiment, the touch sensing method 200 includes the following steps: In the step S1, the charge measurer CHM releases the charges on the first input terminal of the amplifier OP with the first amount of charges. In an embodiment, the charge measurer CHM can utilize the capacitor C1 (see FIG. 4) to achieve the operation of releasing the charges on the first input terminal of the amplifier OP with the first amount of charges. In another embodiment, the charge measurer CHM can also utilize the capacitors C1˜C2 to achieve the operation of releasing the charges on the first input terminal of the amplifier OP with the first amount of charges.

In the step S2, the charge measurer CHM releases the charges on the first input terminal of the amplifier OP with the second amount of charges. In an embodiment, the second amount of charges is different from the first amount of charges. In another embodiment, the charge measurer CHM can utilize the capacitor C2 to release the charges on the first input terminal of the amplifier OP with the second amount of charges.

In the step S3, the touch sensing device TSR estimates an original sensed charge on the first input terminal of the amplifier OP according to a number of times releasing the charges with the first amount of charges and a number of times releasing the charges with the second amount of charges. In an embodiment, the touch sensing device TSR estimates the original sensed charge on the first input terminal of the amplifier OP after the comparator CMP provides the disable signal DN to the charge measurer CHM.

Thereby, the measurement time of the charge measurer CHM can be reduced while maintaining the accuracy.

It should be noted that the details of the touch sensing method 200 can be referred to the above paragraphs, and thus will not be described herein.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A touch sensing device, comprising:
an amplifier having an input terminal and an output terminal;
a charge measurer, electrically connected to the input terminal of the amplifier and configured to measure a volume of charges on the input terminal of the amplifier with different charge measuring basis; and
a comparator, configured to compare an output voltage on the output terminal of the amplifier with a reference voltage.

2. The touch sensing device of claim 1, wherein the charge measurer comprises:
a first capacitor; and
a second capacitor;
wherein the charge measurer uses the first capacitor and the second capacitor to measure an original sensed charge on the input terminal of the amplifier with different charge measuring basis.

3. The touch sensing device of claim 2, wherein the charge measurer further comprises:
a first switch, electrically connected between the first capacitor and the input terminal of the amplifier;
a second switch, electrically connected between the second capacitor and the input terminal of the amplifier; and
a third switch, electrically connected between the first capacitor and a charge releasing terminal.

4. The touch sensing device of claim 3, wherein conduction periods of the first switch and the third switch are different.

5. The touch sensing device of claim 3, wherein the charge measurer further comprises:
a fourth switch, electrically connected between the first capacitor and a power supply terminal.

6. The touch sensing device of claim 5, wherein conduction periods of the first switch and the fourth switch are different.

7. The touch sensing device of claim 1, wherein the charge measurer comprises:
a variable capacitor; and
a variable capacitor switch, electrically connected between the variable capacitor and the input terminal of the amplifier.

8. The touch sensing device of claim 1, wherein the comparator is also configured to provide a disable signal to stop the operation of the charge measurer according to a comparing result of the output voltage and the reference voltage.

9. A touch sensing method, comprising:
(a) releasing charges on an input terminal of an amplifier with a first volume of charges;
(b) releasing the charges on the input terminal of the amplifier with a second volume of charges, wherein the first volume of charges and the second volume of charges are different; and
(c) estimating an original sensed charge on the input terminal of the amplifier according to a number of times releasing the charges on the input terminal of the amplifier with the first volume of charges and a number of times releasing the charges on the input terminal of the amplifier with the second volume of charges.

10. The touch sensing method of claim 9, wherein the step (a) comprises releasing the charges on the input terminal of the amplifier with a first capacitor and the step (b) comprises releasing the charges on the input terminal of the amplifier with a second capacitor, wherein a capacitance of the second capacitor is different from a capacitance of the first capacitor.

11. The touch sensing method of claim 10, wherein the step (a) further comprises conducting a first switch electrically connected between the first capacitor and the input terminal of the amplifier to release the charges on the input terminal of the amplifier to the first capacitor and the step (b) further comprises conducting a second switch electrically connected between the second capacitor and the input terminal of the amplifier to release the charges on the input terminal of the amplifier to the second capacitor.

12. The touch sensing method of claim 11, wherein the step (a) further comprises conducting a third switch electrically connected between the first capacitor and a charge releasing terminal to release the charges on the first capacitor to the charge releasing terminal.

13. The touch sensing method of claim 12, wherein conduction periods of the first switch and the third switch are different.

14. The touch sensing method of claim 11, wherein the step (a) further comprises conducting a fourth switch electrically connected between the first capacitor and a power supply terminal to provide the charges on the power supply terminal to the first capacitor.

15. The touch sensing method of claim 11, wherein conduction periods of the first switch and the fourth switch are different.

16. The touch sensing method of claim 9, wherein the step (a) further comprises releasing the charge on the input terminal of the amplifier with a variable capacitor having a first capacitance and the step (b) further comprises releasing the charge on the input terminal of the amplifier with the variable capacitor having a second capacitance, wherein the second capacitance is different from the first capacitance.

17. The touch sensing method of claim 9, wherein the step (a) further comprises releasing the charges on the input terminal of the amplifier with a first capacitor and a second capacitor and the step (b) further comprises releasing the charges on the input terminal of the amplifier with the second capacitor.

18. A touch sensing device, comprising:
an amplifier having an input terminal and an output terminal;
a first switch, wherein a first terminal of the first switch is electrically connected to the input terminal of the amplifier;
a first capacitor, wherein a first terminal of the first capacitor is electrically connected to a second terminal of the first switch;
a second switch, wherein a first terminal of the second switch is electrically connected to the input terminal of the amplifier;
a second capacitor, wherein a first terminal of the second capacitor is electrically connected to a second terminal of the second switch;
a third switch, wherein a first terminal of the third switch is electrically connected to a charge releasing terminal; and
a comparator, wherein a first input terminal of the comparator is electrically connected to the output terminal of the amplifier, and a second input terminal of the comparator is configured to receive a reference voltage.

19. The touch sensing device of claim 18, wherein conduction periods of the first switch and the third switch are different.

20. The touch sensing device of claim 18, further comprising:
a fourth switch electrically connected between the first capacitor and a power supply terminal, wherein conduction periods of the first switch and the fourth switch are different.
